(19) United States
(12) Patent Application Publication
(10) Pub. No.: US 2010/0176722 A1
(43) Pub. Date: Jul. 15, 2010

(54) HIGH-PRESSURE DISCHARGE LAMP

(75) Inventors: Roland Huettinger, Kaufering (DE); Andreas Kloss, Neubiberg (DE); Marko Kaening, Muenchen (DE); Klaus Stockwald, Germering (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/602,169

(22) PCT Filed: Apr. 29, 2008
(86) PCT No.: PCT/EP2008/055270

§ 371 Date: Nov. 30, 2009

(30) Foreign Application Priority Data
May 31, 2007 (DE) 20 2007 007 688.6

(51) Int. Cl. H01J 61/36

(52) U.S. Cl. 313/623

(57) ABSTRACT

A high-pressure discharge lamp may include a ceramic discharge vessel that encloses a discharge volume and at whose ends capillaries are fitted, an electrode system being led through in each capillary and sealed there, use being made of at least one electrode system that is based on tungsten and has an electrode head made from tungsten as first segment and a shaft made from tungsten as second segment, as well as a multipartite leadthrough having a pin projecting on the outside at the end of the capillary, wherein the multipartite leadthrough has a central cylindrical leadthrough part made from tungsten as third segment of the electrode system inside the capillary, which adjoins the second segment, as well as a fourth multipartite segment inside the capillary, consisting of a core pin that is made from tungsten, has a diameter of at most 300 μm and is partially surrounded by a tubular sleeve, the pin being connected to the projecting pin, a gap remaining between the sleeve and projecting pin, and the end of the capillary being sealed by means of solder glass up to at least the beginning of the sleeve.

### TECHNICAL FIELD

The invention proceeds from a high-pressure discharge lamp having a ceramic discharge vessel in accordance with the preamble of claim 1.

### PRIOR ART

EP-A 926 703 discloses a high-pressure discharge lamp in the case of which an electrode system is composed of a number of parts. Two parts consist respectively of tungsten, specifically the electrode shaft, including a filament, and a central leadthrough part. The electrode system further includes a molybdenum filament pushed onto the leadthrough part, and a terminating leadthrough part made from niobium.

Such a design is not attacked by normal fills. The dead space is filled up in this case by the molybdenum filament or similar structure, which are based on molybdenum.

### SUMMARY OF THE INVENTION

The object of the present invention is to provide an electrode system for a high-pressure discharge lamp that also resists particularly aggressive fills.

This object is achieved by the characterizing features of claim 1.

Particularly advantageous refinements are to be found in the dependent claims.

According to the invention, the electrode system is now produced completely from tungsten material, which also resists particularly aggressive fills. However, the coefficient of thermal expansion of tungsten is not adapted to ceramic capillaries as ends of a discharge vessel. There is thus a need for a novel design.

The electrode itself, that is to say shaft and head, as well as the leadthrough system itself, now are produced from tungsten material. In this case tungsten can be provided with suitable dopings. The complete system consists of four parts that are substantially of cylindrical shape. However, each of the four segments has a different diameter. The transition zones between the segments can be arbitrarily configured, for example they can be of conical or stepped design. The electrode system can be fabricated in one part from uniform material and be produced in one piece, for example by eroding the diameter, laser processing etc.

However, the four segments preferably consist of individual parts that are suitably combined, for example by welding, soldering, a mechanical plug and socket connection, etc.

The first segment is the electrode head. The second segment is the electrode shaft, whose diameter is smaller than or at most equal to that of the head. The third segment is a central leadthrough part that fills up the dead space in a capillary as well as possible. Its diameter is preferably 85 to 95% of the capillary inside diameter. The fourth segment is the terminating leadthrough part, which is led through the sealing region at the end of the capillary, and sealed there by means of solder glass.

According to the invention, the fourth segment is a core pin made from tungsten with a maximum diameter of 300 μm, which is additionally surrounded by a sleeve made from ceramic, in particular PCA or the like. The sleeve is preferably shorter over its axial length by 0.3 . . . 1.0 mm than the core pin that it surrounds.

This part is welded to a niobium pin projecting on the capillary or to a pin made from niobium-like material as concerns the coefficient of thermal expansion. The projecting pin and the weld are completely surrounded by a solder glass.

Since the entire electrode system consists of tungsten, it resists any sort of aggressive fill. Consequently, it is possible to attain substantial advantages by comparison with a molybdenum-containing electrode system.

A further particular advantage of the novel electrode system is that the spacing along the electrodes and electrode leadthrough capillary is of very uniform design.

Convection of the fill is substantially reduced thereby and leads to a reduction in local leaching of the capillary inner wall.

This electrode system is particularly well suited to metal halide fills, which dispense with mercury entirely or virtually completely.

### BRIEF DESCRIPTION OF THE DRAWINGS

The aim below is to explain the invention in more detail with the aid of a number of exemplary embodiments. In the figures:

FIG. 1 shows a high-pressure discharge lamp in section; and

FIG. 2 shows an electrode system in the capillary.

### PREFERRED EMBODIMENT OF THE INVENTION

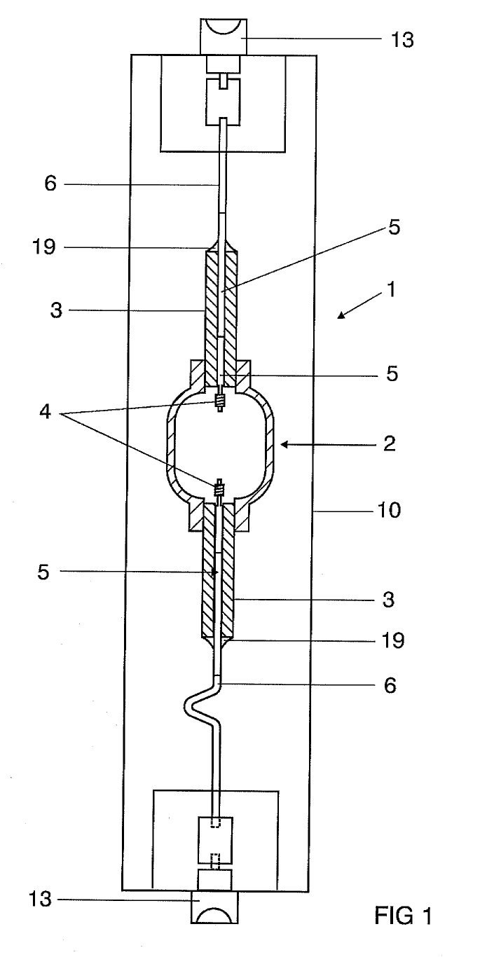

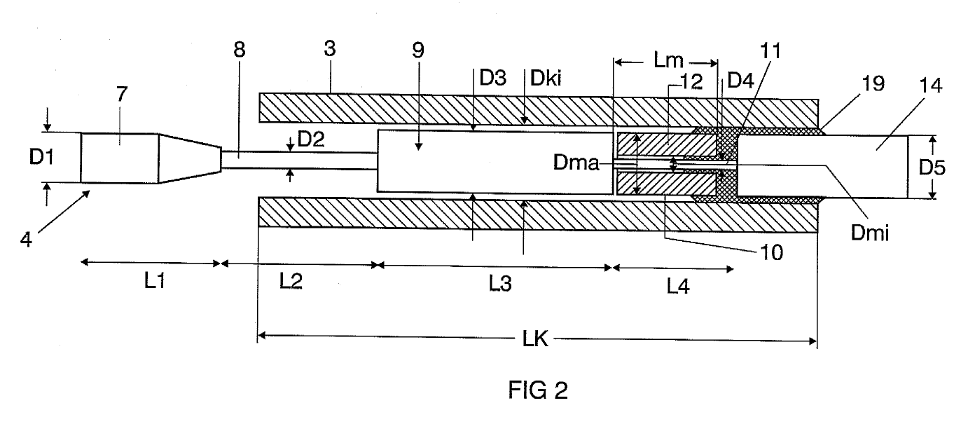

An exemplary embodiment of a metal halide high-pressure discharge lamp 1 is shown in FIG. 1. It has a ceramic discharge vessel 2 that is closed at the two ends, and is seated in an outer bulb 10. It is elongated and has at its two ends capillaries 3 with an inside diameter Dki and an axial length LK, see FIG. 2. Seated against one another in the interior of the discharge vessel are two electrodes 4 that are fastened on leadthroughs 5. The leadthroughs are led to the outside through the capillaries 3. The end of the leadthrough is sealed in the capillary by means of solder glass 19. The leadthrough is connected via a supply lead 6 to a socket contact 13 on the end of the outer bulb. The fill is preferably free of Hg and contains, in particular, rare earth iodides, such as cerium iodide, and aluminum iodide as well as thallium iodide. Another possibility for the fill is specified in DE-A 102 54 969, for example.

The electrode system is shown in detail in FIG. 2. The electrode has a head 7 made from tungsten with a diameter D1 and the axial length L1. The head can be formed in solid fashion or by a filament. This head is the first segment of the electrode system. Adjacent thereto is the electrode shaft 8 with the axial length L2, which is likewise fabricated from tungsten. Its diameter D2 is normally substantially smaller than that of D1, but it can also be at most as great as that of D1. The electrode shaft 8 forms the second segment. Adjacent thereto as third segment is a central cylindrical front leadthrough part 9 made from tungsten. Its diameter D3 is greater than that of D1. Its axial length is L3.

Adjacent thereto, finally as fourth segment, is a combined leadthrough part 10. It consists of a core pin 11 made from tungsten with a diameter D4 of preferably 200 to 300 μm. A practical lower limit for the diameter of the core pin is 100 μm. The core pin 11 is surrounded by a tubular sleeve 12 with the axial length Lm. Its outside diameter Dma corresponds approximately to the diameter D3. The sleeve is preferably made from ceramic. It is fabricated from Al₂O₃, mostly PCA, it being possible for the PCA to be doped or undoped. It has an inside diameter Dmi that is adapted to the core pin 11. As the end piece of the leadthrough, a niobium pin 14 is adjacent to the core pin. The diameter D5 of the niobium pin should likewise be closely adapted to the bore of the capillary.

The following relations are preferably to be observed between the diameters D1 to D5 as well as Dm:
D1=(0.6 to 0.95)*Dki;
D2=(0.2 to 1.0)*D1, preferably (0.2 to 0.5)*D1;
D3=(0.8 to 0.95)*Dki;
D4≦300 μm;
Dma=(0.75 to 0.95)*Dki;
Dmi=D4+(20 to 100) μm;
D5=(0.8 to 0.95)*Dki.

The following relations are preferably to be observed between the axial lengths of the four segments L1, L2, L3 and L4 and the axial length Lm in the sleeve:
Lm=L4−(0.3 to 1.0) mm;
L1=(0.5 to 3.0)*D1;
L2=(0.5 to 5.0)*L1;
L3=(0.3 to 0.8)*LK;
L4=(3.0 to 5.0) mm.

The system as outlined dispenses with the use of molybdenum as material for the leadthrough, since molybdenum is not sufficiently resistant to corrosion. Furthermore, it turns out in general to be disadvantageous when use is made of a wound item as component of the leadthrough, since the inhomogeneous structure of a wound element of variable outside diameter leads to undesirable leaching in the capillary. Consequently, according to the invention there is implemented for the first time a system that is free of molybdenum and of wound elements and is based on the material tungsten, that is to say largely predominantly contains tungsten, if appropriate with additives or as an alloy, and that nevertheless ensures reliable sealing by means of solder glass. This object is served by the ceramic sleeve in conjunction with the thin tungsten wire as core pin. The solder glass extends from outside from the niobium pin up to the beginning of the ceramic sleeve. Solder glasses known per se are suitable as solder glass.

It is well known that niobium can be sealed in effectively. In comparison with ceramic, the coefficient of thermal expansion of tungsten is so large that it is possible at most to seal a tungsten pin with a diameter of 300 μm.

The sleeve is retained on the core pin, for example by a weld point serving as spacer.

Overall, the sum L1+L2+L3+L4 is somewhat longer than the capillary length LK, it being the head of the electrode that projects from the capillary at one end, while it is the sealed niobium pin at the other end.

It is advantageous when the sleeve lies loosely against the third segment. It should be delimited from the niobium pin by a gap that has an axial length of between 0.2 and 0.8 mm, in order, firstly, to take account of the different thermal expansion so as to create sufficient space for fastening and, overall, to be able to bring the solder glass sufficiently up to the tungsten pin and thereby to be able to produce a reliable seal.

It is not the material of the pin projecting outside on the end of the capillary that is important; what is decisive is its coefficient of thermal expansion, which is adapted to the ceramic and is best implemented by niobium.

1. A high-pressure discharge lamp, comprising:
a ceramic discharge vessel that encloses a discharge volume and at whose ends capillaries are fitted,
an electrode system being led through in each capillary and sealed there, use being made of at least one electrode system that is based on tungsten and has an electrode head made from tungsten as first segment and a shaft made from tungsten as second segment, as well as a multipartite leadthrough having a pin projecting on the outside at the end of the capillary,
wherein the multipartite leadthrough comprises a central cylindrical leadthrough part made from tungsten as third segment of the electrode system inside the capillary, which adjoins the second segment, as well as a fourth multipartite segment inside the capillary, consisting of a core pin that is made from tungsten, has a diameter of at most 300 μm and is partially surrounded by a tubular sleeve, the pin being connected to the projecting pin, a gap remaining between the sleeve and projecting pin, and the end of the capillary being sealed by means of solder glass up to at least the beginning of the sleeve.

2. The high-pressure discharge lamp as claimed in claim 1, wherein the first four segments of the electrode system are fabricated from the same tungsten material.

3. The high-pressure discharge lamp as claimed in claim 1, wherein the following dimensions apply:
D1=(0.6 to 0.95)*Dki;
D2=(0.2 to 1.0)*D1, preferably (0.2 to 0.5)*D1;
D3=(0.8 to 0.95)*Dki;
D4≦300 μm;
Dma=(0.75 to 0.95)*Dki;
Dmi=D4+(20 to 100) μm;
D5=(0.8 to 0.95)*Dki.

4. The high-pressure discharge lamp as claimed in claim 1, wherein the following dimensions apply:
Lm=L4−(0.2 to 1.0) mm;
L1=(0.5 to 3.0)*D1;
L2=(0.5 to 5.0)*L1;
L3=(0.3 to 0.8)*LK;
L4=(3.0 to 5.0) mm.

5. The high-pressure discharge lamp as claimed in claim 4, wherein a gap remains between the sleeve and projecting pin with an axial length of 0.2 to 0.8 mm.

6. The high-pressure discharge lamp as claimed in claim 1,
wherein the pin is made from niobium.

7. The high-pressure discharge lamp as claimed in claim 2,
wherein the first four segments of the electrode system are produced in one piece.

8. The high-pressure discharge lamp as claimed in claim 3,
wherein the following dimension applies:
D2=(0.2 to 0.5)*D1.
